(19) United States
(12) Patent Application Publication
(10) Pub. No.: US 2023/0077934 A1
(43) Pub. Date: Mar. 16, 2023

(54) Hair Clipper Device with Replaceable Cover

(71) Applicant: Patricia Lin, Calgary (CA)

(72) Inventor: Patricia Lin, Calgary (CA)

(21) Appl. No.: 17/534,524

(22) Filed: Nov. 24, 2021

Related U.S. Application Data
(60) Provisional application No. 63/243,289, filed on Sep. 13, 2021.

(51) Int. Cl. B26B 19/38; B26B 19/46; B26B 19/04

(52) U.S. Cl. CPC B26B 19/3813; B26B 19/46; B26B 19/3873; B26B 19/046

(57) ABSTRACT

The present invention relates generally to the field of hair care accessories. More specifically, the present invention relates to a hair clipper, cutter or trimer device with a replaceable or interchangeable cover. The cover removably-attaches to the hair clipper and has an opening so that the blades may operate freely and at least one opening in the side walls to provide access to the operational features of the hair clipper. The cover may resemble any vehicle, character, animal, object, item, shape or other themed configuration. In this manner, the clipper can be reconfigured with a plurality of differing appearances, depending on the preferences of the barber or hair stylist or the individual getting a haircut.

### CROSS-REFERENCE TO RELATED APPLICATION

The present application claims priority to, and the benefit of, U.S. Provisional Application No. 63/243,289, which was filed on Sep. 13, 2021, and is incorporated herein by reference in its entirety.

### FIELD OF THE INVENTION

The present invention relates generally to the field of hair care accessories. More specifically, the present invention relates to a hair clipper device with a replaceable or interchangeable cover which is intended to be aesthetically appealing to the individual receiving a haircut. The cover magnetically or otherwise removably-attaches to the hair clipper, while not obstructing the blades, operating buttons or lever of the clipper or other hair care accessory during use. In differing embodiments, the cover may resemble any vehicle, character, animal, object, item, shape or other configuration which may be appealing to the particular clientele or user of the device. In this manner, the clipper or hair care accessory can be reconfigured with a plurality of differing appearances using differing replaceable or interchangeable covers. Therefore, the appearance of the clipper can be changed depending on the preferences of the barber, hair stylist or the individual getting a haircut. Accordingly, the present disclosure makes specific reference thereto. Nonetheless, it is to be appreciated that aspects of the present invention are also equally applicable to other like applications, devices and methods of manufacture.

### BACKGROUND

Children, teenagers and adults regularly need haircuts to maintain a clean, trim, well-groomed and presentable appearance. However, many young children and others become extremely stressed while receiving a haircut due to the sound, appearance or vibration of hair clippers or just generally having to sit still for a prolonged period of time without being entertained. This can result in anxiety and the child crying, complaining and/or fidgeting, which is undesirable for both the child, the hair stylist and the parent or guardian. In addition, this reaction can prolong the duration of the haircut and frustrate the individual performing the haircut. Further, children may be so scared of getting a haircut that they may refuse getting a haircut altogether. Finally, hair clippers and other hair accessories known in the art are typically similar in general appearance and structure, and only differ in color and material based on the manufacturer of the clipper or other device.

Therefore, there exists a long-felt need in the art for an improved hair clipper. There also exists a long-felt need in the art for a hair clipper, trimmer or other hair care accessory with a replaceable cover. The cover allows a user, such as a barber, hair stylist or parent, to change or mask the appearance of the hair clipper. In addition, there is a long-felt need in the art for a hair clipper with a replaceable cover which allows the hair clipper device to appear more appealing to a young child or other individual getting a haircut.

The subject matter disclosed and claimed herein, in one embodiment thereof, comprises a hair clipper with a replaceable cover. The invention includes a hair clipper that has a body that receives a replaceable or interchangeable cover. The cover magnetically or otherwise removably attaches to the clipper or trimmer, while not obstructing the blades, operating buttons or lever of the clipper or trimmer while in use. In differing embodiments, the cover may resemble any vehicle, character, animal, object, item, shape or other configuration which may be appealing to the user, such as sporting equipment like a helmet, bat or sports ball with a different team emblem. In this manner, the clipper or trimmer can be reconfigured with a plurality of differing appearances using differing covers. Therefore, the appearance of the clipper or trimmer can be changed depending on the preferences of the barber, hair stylist or the individual getting a haircut.

In this manner, the hair clipper device with a replaceable cover of the present invention accomplishes all of the forgoing objectives and provides an improved hair clipper. The appearance of the clipper can further be easily changed by a user based on his or her preferences and desires, and allows the clipper or trimmer to have the appearance of a plurality of items, objects, and products that existing hair clippers from the factory or manufacturer cannot mimic. As a result, the cover allows the hair clipper to appear more appealing to a young child or other individual getting a haircut, and to barbers or hair stylists who desire a clipper or trimmer with a non-traditional appearance and to put their customers at ease.

### SUMMARY OF THE INVENTION

The following presents a simplified summary in order to provide a basic understanding of some aspects of the disclosed innovation. This summary is not an extensive overview, and it is not intended to identify key or critical elements or to delineate the scope thereof. Its sole purpose is to present some general concepts in a simplified form as a prelude to the more detailed description that is presented later.

The subject matter disclosed and claimed herein, in one embodiment thereof, comprises a hair clipper device with a replaceable cover. The invention includes a hair clipper that has a body that receives a replaceable or interchangeable cover. The clipper and the replaceable cover may have a magnetic metal material or a plastic material with an embedded magnet or other fasteners such as snaps, such that the replaceable cover can magnetically or removably-attach to the body of the clipper or trimmer. However, the hair clipper of the device may be used with or without the cover. The clipper or trimmer preferably has all known conventional features of hair clippers known in the art, and has a side surface with a lever or other operational settings or buttons that allow a user to raise or lower the blades of the clipper, change speed or the like. The clipper further includes at least one blade guard that allows a user to cut hair to specific lengths. The at least one blade guard may be any conventional guard length. In addition, one embodiment of the device may have a kit that has a plurality of guards of a plurality of differing guard lengths. The clipper may also contain a power cord or a USB port that allows a user to charge an internal battery of the device.

In differing embodiments, the body of the replaceable cover may resemble a plurality of items such as, but not limited to, a vehicle of any make, model or brand known in the art, a character, an animal, an object, a generic or branded item, a shape, sporting accessory or other fanciful configuration. However, in one preferred embodiment, the body and cover resembles a vehicle such as an automobile. When attached to the body of the clipper, the cover is positioned such that it does not obstruct the blades and/or lever or other operational features of the clipper or trimmer while the clipper is in use. In this manner, a user can apply a plurality of differing covers of differing appearances to the clipper while retaining full cutting functionality of the clipper or trimmer. Any embodiment of the device may also feature a plurality of covers of a plurality of differing appearances.

Accordingly, the hair clipper device with replaceable cover of the present invention is particularly advantageous as it provides an improved, customizable hair clipper. The appearance of the clipper can further be easily changed by a user based on his or her preferences and desires or those of the individual receiving the haircut, and allows the clipper to have the appearance of a plurality of items, objects and products that existing hair clippers cannot mimic. In addition, the cover allows the hair clipper device to appear more appealing to a young child or other individual getting a haircut, or to the barber, hair stylist or other individual giving the haircut.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a hair clipper of the present invention without the replaceable cover in accordance with the disclosed architecture;

FIG. 2 illustrates a perspective view of one potential embodiment of a hair clipper with a replaceable cover of the present invention with the replaceable cover in accordance with the disclosed architecture;

FIG. 3A illustrates an enhanced perspective view of one potential embodiment of a hair clipper with a replaceable cover of the present invention with the replaceable cover in accordance with the disclosed description;

FIG. 3B illustrates the fastening features of the replaceable cover of view of one potential embodiment of a hair clipper with a replaceable cover of the present invention in accordance with the disclosed architecture;

FIG. 4 illustrates a perspective view of one potential embodiment of the replaceable cover of one potential embodiment of a hair clipper with a replaceable cover of the present invention in accordance with the disclosed architecture;

FIG. 5 illustrates a perspective view of one potential embodiment of the replaceable cover of one potential embodiment of a hair clipper with a replaceable cover of the present invention in accordance with the disclosed architecture;

FIG. 6 illustrates a perspective view of one potential embodiment of the replaceable cover of one potential embodiment of a hair clipper with a replaceable cover of the present invention in accordance with the disclosed architecture; and

FIG. 7 illustrates a top view of one potential embodiment of the replaceable cover of one potential embodiment of a hair clipper with a replaceable cover of the present invention having a number of replaceable covers, attachment elements, personalization stickers and clipper in accordance with the disclosed architecture.

### DETAILED DESCRIPTION OF THE INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for an improved hair care accessory such as a hair clipper. There also exists a long-felt need in the art for a hair clipper with a replaceable or interchangeable cover that allows a user to change the appearance of the hair clipper. In addition, there is a long-felt need in the art for a hair clipper with a replaceable or interchangeable cover which allows the hair clipper to appear more appealing to a young child or other individual getting a haircut or to the individual giving the haircut.

The present invention, in one exemplary embodiment, is comprised of a hair clipper with a replaceable or interchangeable cover. The invention includes a hair clipper that has a body that receives a replaceable or interchangeable cover. In various embodiments, the clipper or trimmer and the replaceable cover may have a magnetic metal material or a plastic material with embedded magnets or other fasteners to allow the cover to be removably-attached to the clipper or trimmer. As a result, the replaceable or interchangeable cover can magnetically or otherwise be removably-attached to the body of the clipper or trimmer. However, the hair clipper of the device may be used with or without the cover. The body of the cover may resemble a plurality of items such as, but not limited to, a vehicle of any make, model or brand known in the art, a character, an animal, an object, a generic or branded item, a shape, a sporting accessory or themed item. In one exemplary embodiment, the body and cover resembles a vehicle such as an automobile. When attached to the body of the clipper, the cover is positioned such that it does not obstruct the blades, operational features or lever of the clipper. Therefore, a user can apply a plurality of differing covers of differing appearances to the clipper or trimmer while retaining full cutting functionality of the clipper or hair care accessory. It is also contemplated that any embodiment of the invention may also feature a plurality of covers of a plurality of differing appearances.

The hair clipper of the device preferably has all known conventional features of hair clippers known in the art, and has a side surface with a lever or other operational controls that allows a user to raise or lower the blades of the clipper, change cutting speeds and other functions needed to operate the cutter, clipper or trimmer. The clipper has at least one blade guard that allows a user to cut hair to specific lengths, and the at least one blade guard may be any conventional guard length. In addition, one embodiment of the device may have a kit that has a plurality of guards of a plurality of differing guard lengths. The clipper may also contain a power cord or a USB port that allows a user to charge an internal battery of the device.

Accordingly, the hair clipper device with a replaceable cover of the present invention is particularly advantageous as it provides the appearance of a hair clipper to be easily changed by a user based on their preferences and desires or the individual receiving the haircut, and allows the clipper to have the appearance of a plurality of items, objects and products that existing hair clippers cannot mimic. In addition, the cover allows the hair clipper device to appear more appealing to a young child or others getting a haircut.

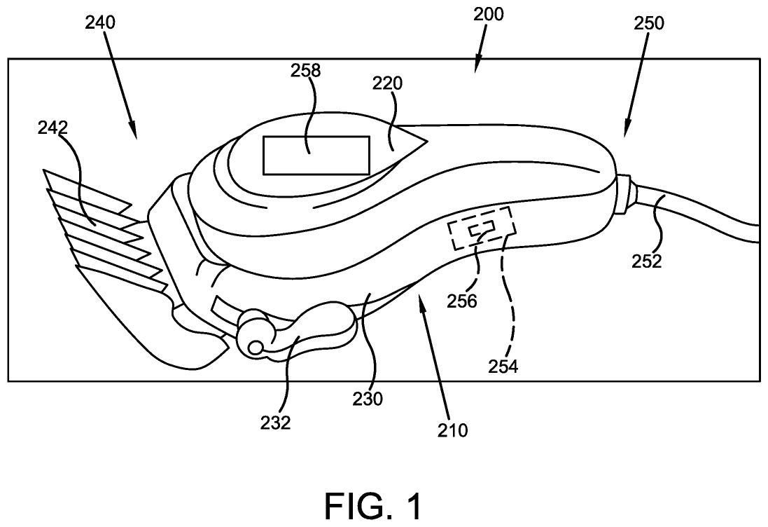

Referring initially to the drawings, FIG. 1 illustrates a perspective view of one potential embodiment of a hair clipper device 100 of the present invention without the replaceable cover 300 in accordance with the disclosed structure. The device 100 includes a hair clipper 200 having a body 210 that receives a replaceable or interchangeable cover 300. It should be noted that in differing embodiments, the hair clipper 200 of the device 100 may be used with or without the cover 300. The clipper 200 is preferably comprised of a magnetic metal body 210 made of stainless steel or aluminum. Alternatively, the body 210 may be comprised of a plastic such as, but not limited to, an acrylic, polycarbonate, polyethylene, thermoplastic, acrylonitrile butadiene styrene, low density polyethylene, medium density polyethylene, high density polyethylene, polyethylene terephthalate, polyvinyl chloride, polystyrene, polylactic acid, acetal, nylon, fiberglass, etc. In an embodiment of the device 100 where the clipper 200 has a plastic body 110, the top surface 220 and/or side surface 230 of the body may have at least one integrated magnet 258. The magnet 258 may further be any magnet type known in the art such as, but not limited to, a neodymium iron boron magnets, samarium cobalt magnets, alnico magnets, ceramic magnets, ferrite magnets, etc.

It is contemplated that the clipper 200 has all known conventional features of hair clippers or trimmers known in the art, in addition to the novel features of the present invention. A side surface 230 of the clipper 200 includes a lever 232 that allows a user to raise or lower the blades 244 of the clipper 200, which are located on the first end 240 of the body 210. The clipper 200 further includes at least one blade guard 242 that can be removably-applied to the blades 244 and allows a user to cut hair to specific lengths. In differing embodiments, the at least one blade guard 242 may be any conventional guard length such as, but not limited to, a number 0 ( 1/16 in.) guard, a number 1 (⅛ in.) guard, a number 2 (¼ in.) guard, a number 3 (⅜ in.) guard, a number 4 (½ in.) guard, a number 6 (¾ in.) guard, a number 7 (⅞ in.) guard, a number 8 (1 in.) guard, a number 10 (1¼ in.) guard, a number 12 (1⅕ in.) guard, etc. In addition, one embodiment of the device 100 may have a kit that has a plurality of guards 242 of a plurality of differing guard lengths.

The second end 250 of the body 210 has a power cord 252 that can be plugged into a standard 120V/240V wall outlet to provide power to an internal battery 254 located within the body 210. The battery 254 may be a disposable battery or a rechargeable battery in the form of an alkaline, nickel-cadmium, nickel-metal hydride battery, etc., such as any 3V-12 volts DC battery or other conventional battery such as A, AA, AAA, etc., that supplies power to the device 100. Throughout this specification the term “battery” may be used interchangeably to refer to one or more wet or dry cells or batteries of cells in which chemical energy is converted into electricity and used as a source of DC power. References to recharging or replacing the battery 254 may refer to recharging or replacing individual cells, individual batteries of cells or a package of multiple battery cells as is appropriate for any given battery technology that may be used. In a differing embodiment, the clipper 200 may be wireless, wherein the battery 254 can be recharged by a USB port 256 located on the top surface 220 or side surface 230. In differing embodiments, the USB port 256 may be a USB-A, USB-B, Micro-B, Micro-USB, Mini-USB or USB-C port. In addition, the port 256 may receive a 9 v/12 v power supply.

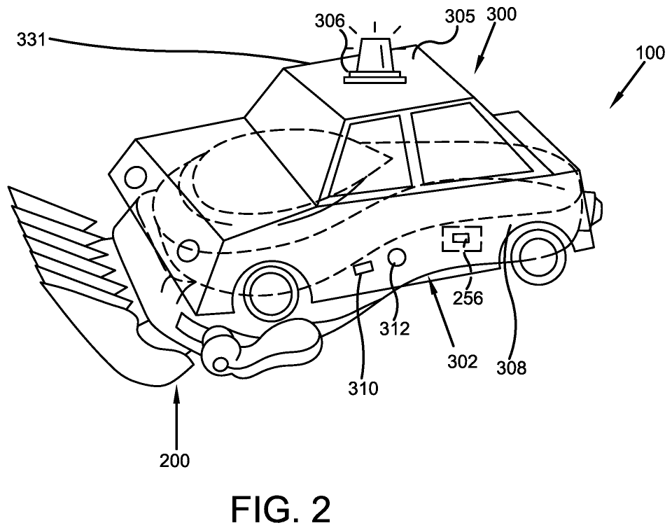

FIG. 2 illustrates a perspective view of one potential embodiment of a hair clipper with a replaceable cover 100 of the present invention with the replaceable cover in accordance with the disclosed architecture. The body 210 further receives a removable and replaceable magnetic cover 300. The cover 300 is preferably comprised of a magnetic metal body 302 made of stainless steel or aluminum. Alternatively, the body 302 may be comprised of a plastic such as, but not limited to, an acrylic, polycarbonate, polyethylene, thermoplastic, acrylonitrile butadiene styrene, low density polyethylene, medium density polyethylene, high density polyethylene, polyethylene terephthalate, polyvinyl chloride, polystyrene, polylactic acid, acetal, nylon, fiberglass, etc. In an embodiment of the device 100 where the cover 300 has a plastic body 302, the underside of a top surface 306 and/or an interior surface of a side surface 308 of the body 302 may have at least one integrated magnet or other fastener 310. The magnet or fastener 310 may further be any magnet type known in the art such as, but not limited to, neodymium iron boron magnets, samarium cobalt magnets, alnico magnets, ceramic magnets, ferrite magnets, etc. Other fasteners can include hook and loop fasteners, snaps and slots and grooves disposed on the body of each of the cover and clipper. Other aesthetic elements 305 such as a siren or flashing light may be applied to the body 302 to increase the appeal and interactivity of the cover and clipper assembly. The at least one magnet or fastener 310 thereby allows the cover 300 to be removably secured to the body 210 of the clipper 200 in a releasable fashion. In addition, the 300 cover can be secured to the body 210 via at least one fastener 312 such as, but not limited to, a screw, a bolt, a snap-button assembly, a hook and loop fastener or various combinations thereof to provide a more secure (but still removable) attachment.

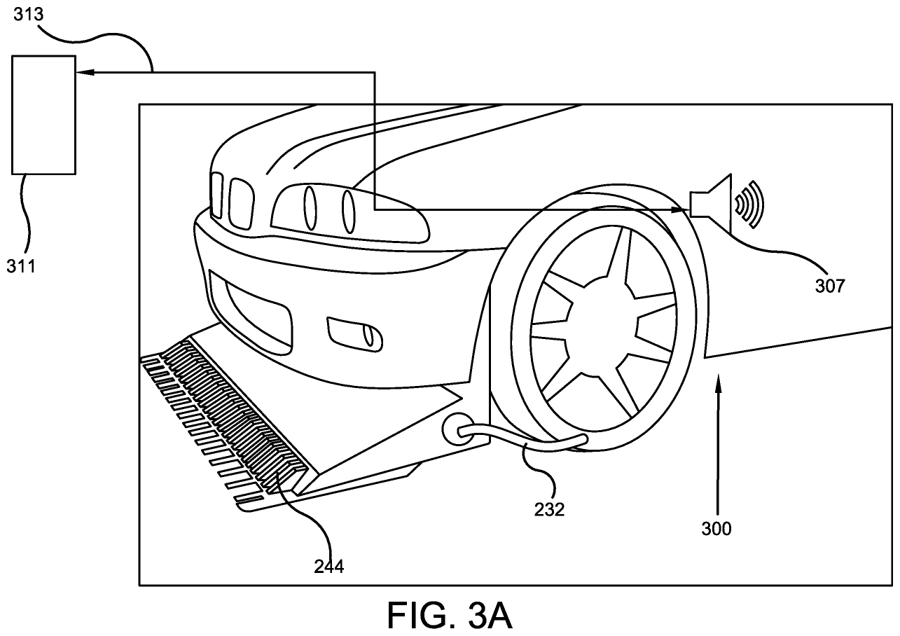

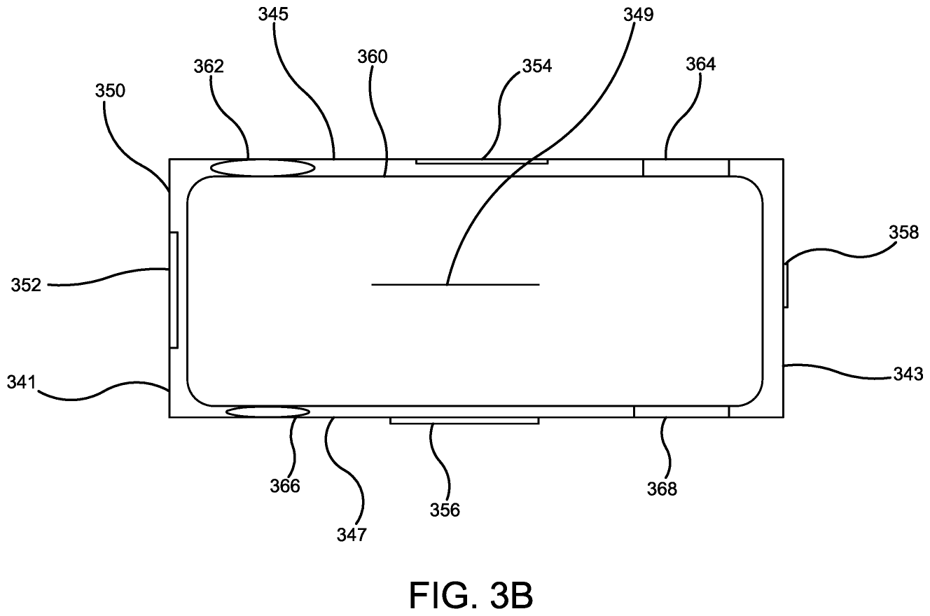

In differing embodiments, the body 302 of the cover 300 may further resemble a plurality of items such as, but not limited to, a vehicle of any make, model or brand known in the art, a character, an animal, an object, a generic or branded item, a shape, sporting accessory or other themed element. However, one exemplary embodiment of the body 302 and cover 300 resembles a vehicle such as an automobile. As best seen in FIG. 3A, any embodiment of the cover 300 is positioned when attached to the body 210 such that it does not obstruct the blades 244 and/or lever 232 of the body 110. In this manner, a user can apply a plurality of differing covers 300 of differing appearances to the hair clipper 200, while retaining full cutting functionality of the clipper 200. It is further contemplated that any embodiment of the device 100 may feature a plurality of covers 300 of a plurality of differing appearances. As a result, the clipper 200 can be changed to the preferences of young children or another individual that is receiving or giving a haircut via the clippers 200. The covers 300 may also be provided with a speaker 307, such that the cover may emit sounds to help cover the noise of the clipper as well as to increase the realism of the cover. The sounds may include for example automobile or traffic sounds, and if other covers are used such as an animal, animal sounds may be emitted from the speaker 307. In addition, if a sporting accessory is provided, the sounds may mimic fans cheering or play-by-play announcing. The speaker can be wirelessly connected 313 to a smart app downloaded on a smart phone 311, so that the user can select sounds from a library as part of the downloaded application. The sounds may include soothing sounds as well as music.

FIG. 3B illustrates the fastening features of the replaceable cover 350 of one potential embodiment of a hair clipper with a replaceable cover 100 of the present invention in accordance with the disclosed architecture. The cover 350 has a plurality of openings 352, 354, 356 and 358 disposed to allow positioning of the cover over the top of the clipper 360, so as to not interfere with the operation of the clipper. For example, the opening 352 is sized and configured for the blades, openings 354 and 356 are used to allow access to the operational controls of the clipper 360 and opening 358 is positioned for a power cord. At least one opening is provided in the sidewalls of the clipper 360, and at least one opening is provided in the front or back wall of the clipper. The openings may be provided directly opposite to one another, may be of the same size or different size, to accommodate the particular feature. For example, the blade opening is larger than the opening needed for the power cord. FIG. 3A also shows a plurality of attachment points 362, 364, 366 and 368 which may be magnets or other snap features. FIG. 3A also shows the front side 341, back side 343, and two side walls 345 and 347 which make up the perimeter of the cover which also has a top 331 (see FIG. 2). The cover is sized and configured so as to accommodate the dimensions of a hair trimmer or cutter. The bottom area 349 of the cover is open.

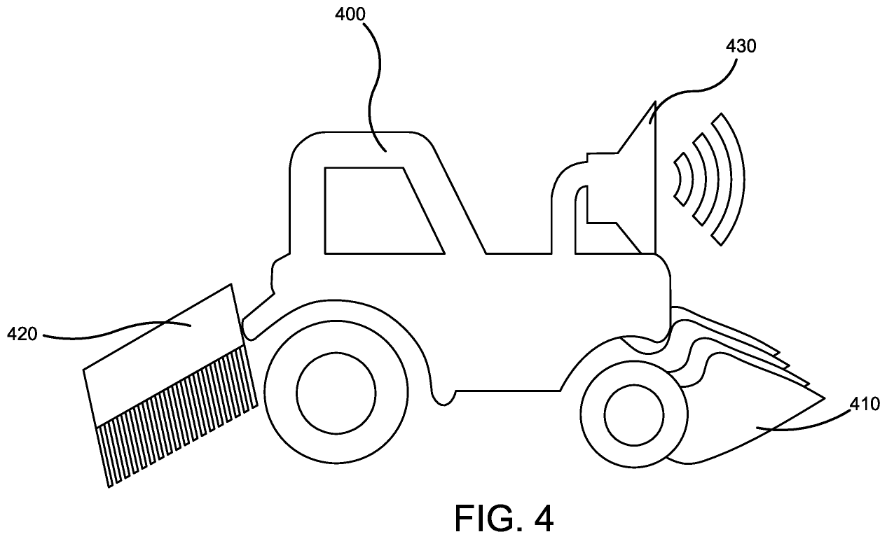

FIG. 4 illustrates a perspective view of one potential embodiment of the replaceable cover 350 of one potential embodiment of a hair clipper with a replaceable cover 100 of the present invention in accordance with the disclosed architecture. The tractor cover 400 has an opening for the blade 410 and a second opening for a comb or other attachment 420 much like an agricultural tractor may have in real-life. A speaker 430 may also be provided with the tractor to mimic various sounds made by a tractor or to play music or other sounds that may be selected by the user or the customer.

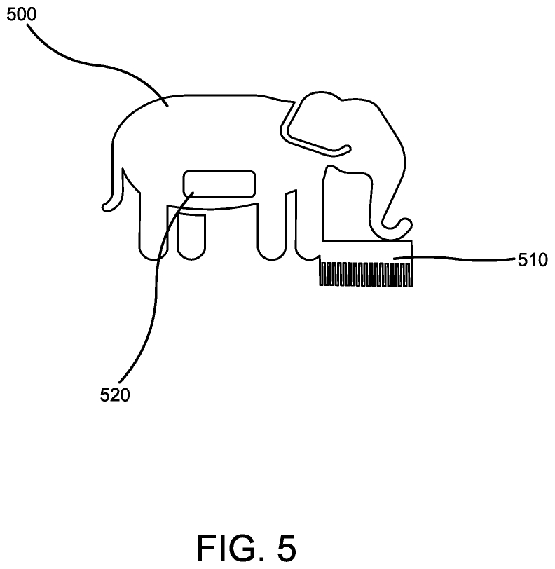

FIG. 5 illustrates a perspective view of one potential embodiment of the replaceable cover 350 of one potential embodiment of a hair clipper with a replaceable cover 100 of the present invention in accordance with the disclosed architecture. In this embodiment, an animal shape is used for the cover 300, such as an elephant 500, and the cover includes an opening 510 for the blades of the clipper to be exposed A second opening 520 is included in the side of the cover to allow access to the operational controls of the clipper or trimmer.

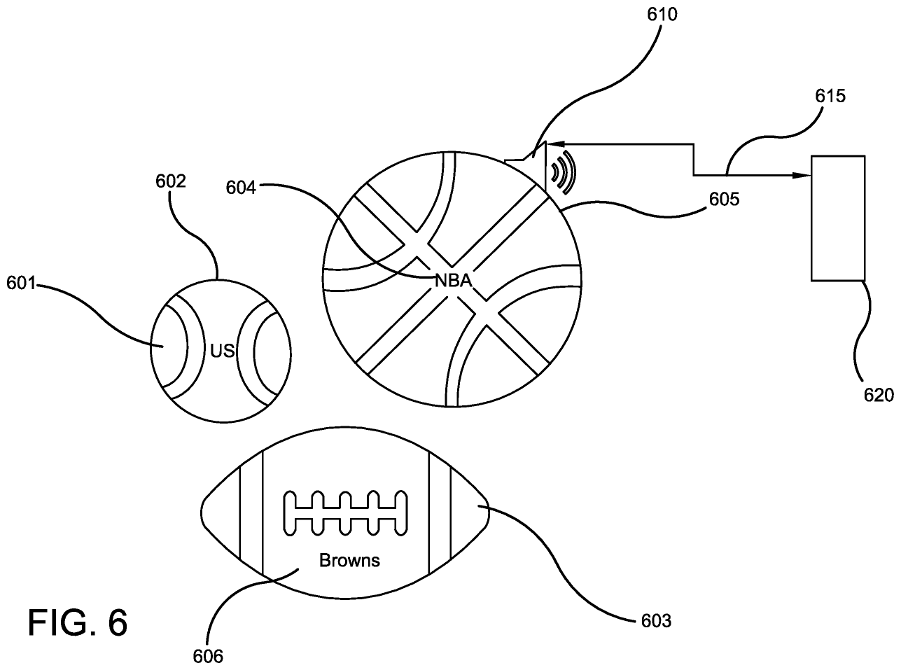

FIG. 6 illustrates a perspective view of one potential embodiment of the replaceable cover 350 of one potential embodiment of a hair clipper with a replaceable cover 100 of the present invention in accordance with the disclosed architecture. A different embodiment of the present invention has sporting goods such as, but not limited to, balls 601, 603 and 605, which are depicted as the cover 300. Each of the balls 601, 603 and 605 has a logo or other indicia 602, 604 and 606. Any of the sporting goods may contain a speaker 610 which is connected 615 to a smart phone 620 having an application for playing sounds relating to the sporting goods, such as game noises or a real-time game.

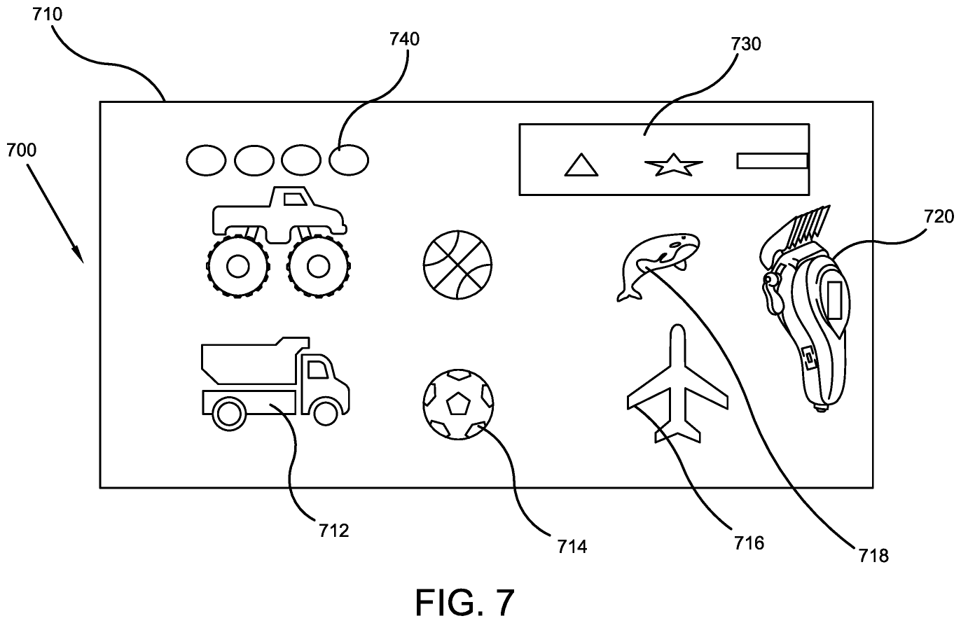

FIG. 7 illustrates a top view of one potential embodiment of the replaceable cover 350 of one potential embodiment of a hair clipper with a replaceable cover 100 of the present invention having a number of replaceable covers, attachment elements, personalization stickers and clipper in accordance with the disclosed architecture. The device 100 may also have a kit 700 which is contained in a package 710. The package 710 holds a plurality of different shaped covers 712, 714, 716 and 718 which can be interchangeably used on the device 720. The user can change the covers 712, 714, 716, 718 depending on the individual preferences of the customer. The kit 700 also includes a series of labels 730, 740 so that the user can decorate the covers 712, 714, 716, 718 or otherwise personalize the covers 712, 714, 716, 718 as needed. Each cover 712, 714, 716, 718 may be provided with magnetic attachment elements and the kit 700 may include additional attachment elements which may be magnets, adhesive patches, hook and loop fasteners, snaps or various combinations of fasteners to allow the user to attach the cover to the cutter 720.

Notwithstanding the forgoing, it is also contemplated that the hair clipper device 100 of the present invention can also be used by pet groomers. Similar to the ability to reduce anxiety in children, so too might it be possible to reduce anxiety in animals through use of the hair clipper device 100 of the present invention. In this regard, the hair clipper device 100 may also add entertainment value to the pet groomer's day.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “hair clipper device with replaceable cover” and “device” are interchangeable and refer to the hair clipper device with replaceable cover 100 of the present invention.

Notwithstanding the forgoing, the hair clipper device with replaceable cover 100 of the present invention and its various components can be of any suitable size and configuration as is known in the art without affecting the overall concept of the invention, provided that they accomplish the above-stated objectives. One of ordinary skill in the art will appreciate that the size, configuration and material of the hair clipper device with replaceable cover 100 as shown in the FIGS. are for illustrative purposes only, and that many other sizes and shapes of the hair clipper device with replaceable cover 100 are well within the scope of the present disclosure. Although the dimensions of the hair clipper device with replaceable cover 100 are important design parameters for user convenience, the hair clipper device with replaceable cover 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A hair clipper device comprising:
a hair clipper; and
a replaceable cover that attaches to a body of the hair clipper and conceals the hair clipper, the replaceable cover further comprising a plurality of openings.

2. The hair clipper device as recited in claim 1, wherein the replaceable cover comprises a light.

3. The hair clipper device as recited in claim 1, wherein the replaceable cover resembles a vehicle, a character, an animal, an object, an item, a shape, a piece of sporting equipment or a themed shape.

4. The hair clipper device as recited in claim 1, wherein the replaceable cover comprises a sound emitting feature in the form of a speaker.

5. The hair clipper device as recited in claim 4, wherein the speaker is wirelessly connected to a smartphone having a previously downloaded application that allows a sound to be played from the speaker.

6. The hair clipper device as recited in claim 5, wherein the sound is one of a soothing sound, an animal sound, a sporting sound, a vehicle sound, a traffic sound, an agricultural sound or a combination thereof.

7. The hair clipper device as recited in claim 1, wherein the replaceable cover attaches to the hair clipper via a magnet, a hook and loop, a snap, an adhesive or a screw fastening means.

8. The hair clipper device as recited in claim 7, wherein the fastening means is a magnet which is attached to a body of the replaceable cover.

9. The hair clipper device as recited in claim 1, wherein a body of the replaceable cover provides a first opening for a plurality of blades of the hair clipper and a second opening for a power cord.

10. The hair clipper device as recited in claim 9, wherein the first and second openings provide access to operational features of the hair clipper.

12. A hair clipper device comprising:
a hair clipper, wherein a body of the hair clipper is further comprised of a blade and a lever that allows a user to raise or lower the blade relative to the body;
an internal battery;
at least one blade guard that can be applied to the blade to allow the blade to cut a piece of hair at a desired length; and
a replaceable cover that removably attaches to a body of the hair clipper.

13. The hair clipper device as recited in claim 12, wherein the replaceable cover attaches to the hair clipper via a magnet, a hook and loop, a snap, an adhesive or a screw fastening means.

14. The hair clipper device as recited in claim 12, wherein the replaceable cover conceals the hair clipper when attached to the hair clipper.

15. The hair clipper device as recited in claim 12, wherein the at least one blade guard is a select one of a number 0 guard, a number 1 guard, a number 2 guard, a number 3 guard, a number 4 guard, a number 6 guard, a number 7 guard, a number 8 guard, a number 10 guard, or a number 12 guard.

16. The hair clipper device as recited in claim 12, wherein the replaceable cover is comprised of an opening for a plurality of blades of the hair clipper.

17. The hair clipper device as recited in claim 16, wherein the opening allows a user to access and use the hair clipper.

18. A hair clipper kit comprising:
a package;
a hair clipper; and
at least two covers that attach to the hair clipper and are contained within the package, wherein each of the at least two covers resemble a vehicle, a character, an animal, an object, an item, a shape, a piece of sporting equipment, or a themed shape.

19. The hair clipper kit as recited in claim 18, wherein the at least one of the at least two covers is magnetically attached to a body of the hair clipper.

20. The hair clipper kit as recited in claim 19, wherein the at least one cover does not obstruct a blade or a lever of the hair clipper when attached to the hair clipper.
